(19) United States
(12) Patent Application Publication
(10) Pub. No.: US 2005/0283980 A1
(43) Pub. Date: Dec. 29, 2005

(54) Scissors

(75) Inventors: Simon David Bathard, Bridgend (GB); Gareth William Humphreys Davies, Bridgend (GB)

Correspondence Address: MILES & STOCKBRIDGE PC, 1751 PINNACLE DRIVE, SUITE 500, MCLEAN, VA, 22102-3833, US

(73) Assignee: Tonic Studios Limited

(21) Appl. No.: 10/878,407

(22) Filed: Jun. 29, 2004

(51) Int. Cl. B26B 1/00; B25F 3/00

(52) U.S. Cl. 30/131

(57) ABSTRACT

Scissors are provided in which each blade 1, 2 has a handle 3, 4 and respective finger rings 5, 6, all formed from metal sheet. Each handle 3, 4 and finger ring 5, 6 has moulded thereover a relatively hard plastics material 9, 10 and at least the portion around the finger rings 5, 6 has moulded thereover a relatively soft plastics material 11, 12. With this arrangement the scissors' mechanical strength is primarily derived from the metal sheet, the relatively rigid plastics material is moulded thereover, following which the relatively soft plastics material then provides a soft covering which is protected from the metal part of the finger ring by the layer of relatively hard plastics material.

### BACKGROUND OF THE INVENTION

This invention relates to scissors of the handheld type and particularly, but not exclusively, to scissors that may be used by left-handed or right-handed people.

It is known for the handle of scissors to be made of a hard plastics material part moulded around end portions of steel scissor blades, the handle part incorporating finger rings lined with a soft elastomer, such as is shown in PCT Patent Publication No. WO 93/06977, the soft elastomer being easily deformable, thereby permitting the scissors to adapt themselves to the fingers of the user. However, a problem with this arrangement is that the mechanical strength of the scissors is largely dictated by the physical characteristics of the plastics handles which therefore need to be sufficiently large in order to prevent breakage during use, but should not be too large since otherwise they may not be capable of being gripped by a person with e.g. a small hand. Therefore a trade off usually has to occur between making the handle of such scissors sufficiently large and hence strong so as to avoid breakage, in use, whilst allowing for the softer finger rings to be easily grasped and therefore be comfortable for the user thereof.

The present invention is derived from the realisation that it would be preferable for substantially the whole of the handle and in particular the whole of the handle surrounding the finger rings to be covered by a relatively soft elastomer, whilst the handle itself is sufficiently strong not to break in normal use and for the size i.e. thickness of the handle not to be unnecessarily bulky such that the construction of such scissors permits the manufacture and use of even relatively small sized scissors adapted for use with small hands, but with soft grip finger rings.

### SUMMARY OF THE INVENTION

According to the invention there is provided scissors in which a blade and handle incorporating a finger ring is formed from a single metal sheet, CHARACTERISED IN THAT the handle and finger ring has moulded thereover a relatively hard plastics material and at least the portion around the finger ring has moulded thereover on top of the relatively hard plastics material a relatively soft plastics material.

With this arrangement the scissors mechanical strength is primarily derived from the metal sheet, and the relatively rigid plastics material moulded thereover, which may typically be polypropylene, can be moulded in a first operation around part of the sheet and then be bonded to a relatively soft elastomer which substantially covers the finger ring portion of the handle. As will be appreciated, it is not generally possible to simply mould a relatively soft plastic directly onto cut metal sheet but, even if it were, the mechanical interaction between the two whilst the scissors are in use would mean that any sharp edges would cut into the soft plastics elastomer, whereas through the use of an intermediate layer of relatively hard plastics this can be avoided, such as by the use of a relatively smooth outer surface onto which the relatively soft polymer can then be moulded.

### BRIEF DESCRIPTION OF THE DRAWINGS

The invention will now be described, by way of example only, with reference to the accompanying drawings in which:

FIG. 1 shows two halves of sheet metal scissor blades with associated handles and associated finger rings,

FIG. 2 shows the scissor blades of FIG. 1 in their assembled condition following the moulding partly thereover of a relatively hard plastics material and a relatively soft plastics material, and

FIG. 3 is an enlarged section along the line ‘X-X’ of the finger rings of FIG. 2.

### DETAILED DESCRIPTION OF THE DRAWINGS

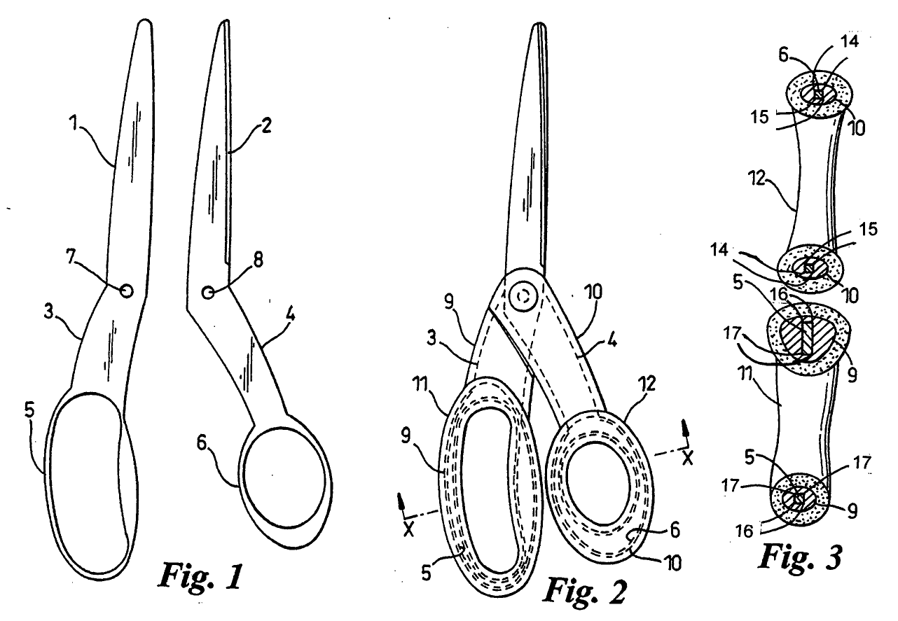

Referring firstly to FIG. 1 there is shown respective halves of scissor blades 1, 2 with associated handles 3, 4—each having respective finger rings 5, 6, each half of the pair of scissors being formed from a single metal sheet in a conventional manner. Between each respective blade and handle 1, 3 and 2, 4 are holes 7, 8 by which they may be pivotally joined together by e.g. a rivet.

As thus far described, the arrangement is conventional but it will be noted that the amount of metal forming the finger rings 5, 6 is very modest and essentially skeletal in nature, even though from a mechanical perspective when the two halves of the scissors are joined together there is still sufficient strength to cut without breaking or bending the finger rings 5, 6.

The skeletal nature of the finger rings 5, 6 shown in FIG. 1 together with the thinness of the metal sheet used to form the blades 1, 2 and the respective handles 3, 4 permits them to have moulded thereover respective hard plastics, such as polypropylene handle covers 9, 10 as shown in FIG. 2 which not only cover substantially all of the sheet metal handles 3, 4 (shown in outline), but also the finger rings 5, 6, as is shown more clearly with reference to FIG. 3, being a section along the line ‘X-X’ of FIG. 2. This ensures that the relatively sharp edges of the finger rings 5, 6 are embedded sufficiently so as not to protrude from the smooth exterior of the handle covers 9, 10 in this region, therefore allowing for the moulding thereover of finger ring covers 11, 12 of relatively soft plastics material such as a material having elastomeric properties.

This construction of scissors has the advantage that, when assembled, they are comfortable to use for left or right handed people while still being of a convenient size and whilst still retaining sufficient mechanical strength for normal cutting operations.

1. Scissors in which a blade and a handle incorporating a finger ring are formed from a single metal sheet, characterised in that the handle and the finger ring have moulded thereover a relatively hard plastics material and at least a portion around the finger ring has moulded thereover on top of the relatively hard plastics material a relatively soft plastics material.

2. Scissors according to claim 1, further characterised in that the amount of metal used to form the finger ring is sufficient to provide only a skeleton over which the relatively hard and relatively soft plastics may be moulded.

3. Scissors according to claim 1, further characterised in that the metal forming the finger ring has sharp edges over which the relatively hard plastics material is moulded.

4. Scissors according to claim 2, further characterised in that the metal forming the finger ring has sharp edges over which the relatively hard plastics material is moulded.

5. The scissors according to claim 1, further characterised in that the finger ring is entirely encased in the relatively hard plastics material.

6. The scissors according to claim 5, further characterised in that the finger ring is also entirely encased in the relatively soft plastics material.

7. A scissors comprising:
a first member formed from a single metal sheet and including a blade, a handle, and a portion extending from the handle so as to define a finger ring;
a first over-moulding of relatively hard plastics material completely encasing said extending portion; and
a second over-moulding of relatively soft plastics material completely encasing said first over-moulding on said extending portion.

8. The scissors according to claim 7, wherein said first over-moulding also encases a portion of the handle adjacent to the finger ring.

9. The scissors according to claim 8, wherein said first over-moulding also encases another portion of the handle including a pivot point between the handle and the blade.

10. The scissors according to claim 9, wherein the metal of the extending portion has sharp edges over which the relatively hard plastics material is moulded.

11. The scissors according to claim 8, wherein the metal forming the finger ring has sharp edges over which the relatively hard plastics material is moulded.

12. The scissors according to claim 7, wherein the metal forming the finger ring has sharp edges over which the relatively hard plastics material is moulded.
